(19) United States
(12) Patent Application Publication
(10) Pub. No.: US 2014/0324342 A1
(43) Pub. Date: Oct. 30, 2014

(54) Systems and Methods for Path Finding in Maps

(71) Applicant: Tencent Technology (Shenzhen) Company Limited, Shenzhen (CN)

(72) Inventor: Chuye Chen, Shenzhen (CN)

(21) Appl. No.: 14/314,107

(22) Filed: Jun. 25, 2014

Related U.S. Application Data
(63) Continuation of application No. PCT/CN2014/070055, filed on Jan. 3, 2014.

(30) Foreign Application Priority Data
Apr. 25, 2013 (CN) 201310148337.2

(51) Int. Cl. G01C 21/34

(52) U.S. Cl. CPC G01C 21/3446
USPC 701/533

(57) ABSTRACT

Systems and methods are provided for path finding. For example, a map is obtained; a plurality of first nodes in the map are determined, the first nodes being reachable nodes in the map; the first nodes are merged to obtain one or more second nodes according to a predetermined order based on at least information associated with one or more predetermined rules; the first nodes are marked as associated with the second nodes; and a path-finding algorithm is executed using the second nodes as independent nodes in order to obtain a path from a start node to a target node.

### CROSS-REFERENCES TO RELATED APPLICATIONS

This application claims priority to Chinese Patent Application No. 201310148337.2, filed Apr. 25, 2013, incorporated by reference herein for all purposes.

### BACKGROUND OF THE INVENTION

Certain embodiments of the present invention are directed to computer technology. More particularly, some embodiments of the invention provide systems and methods for path finding. Merely by way of example, some embodiments of the invention have been applied to maps. But it would be recognized that the invention has a much broader range of applicability.

A path-finding process includes: selecting a position as a target position and an object as a start position, and finding a path from the start position to the target position. Currently, relatively mature path-finding algorithms include: an A* (A-star) path-finding algorithm, a Dijkstra algorithm, etc.

In certain computer applications, the target position and the start position are often placed on a map, and the map is usually divided into a number of cells (e.g., generally small squares), known as nodes, to simplify certain calculations. In a game map, a scene is divided into a number of equal-sized parts, and each part corresponds to a node. A node through which a game character is not allowed to pass corresponds to a barrier node. Path-finding corresponds to a process for finding between two nodes a route which does not include any barrier nodes.

For example, the A-star path-finding algorithm is based on independent nodes. As shown in FIG. 1, to search for a path from a black node towards a target node, eight nodes adjacent to the black node are traversed first (e.g., mesh-filled nodes). A non-barrier node is selected among the eight nodes according to an evaluation function of the A-Star algorithm to continue the search, until the target node is reached or the search fails. It is a feature of the A-star algorithm to determine the search order according to the evaluation function.

The conventional algorithms, such as the A-star algorithm, have some disadvantages. For example, computational complexity often increases rapidly as the distance between the start position and the target position increases, and the path-finding efficiency decreases. If the map is very large, the number of nodes in the map increases correspondingly. It often takes a long time to find a path between two distant nodes, which sometimes results in a freezing situation during the path-finding process.

Hence it is highly desirable to improve the techniques for path finding.

### BRIEF SUMMARY OF THE INVENTION

According to one embodiment, a method is provided for path finding. For example, a map is obtained; a plurality of first nodes in the map are determined, the first nodes being reachable nodes in the map; the first nodes are merged to obtain one or more second nodes according to a predetermined order based on at least information associated with one or more predetermined rules; the first nodes within the second nodes are marked as associated with the second nodes; and a path-finding algorithm is executed using the second nodes as independent nodes in order to obtain a path from a start node to a target node.

According to another embodiment, a device for path finding includes: a node-determining unit, a node-merging unit, and a path-finding-calculation unit. The node-determining unit is configured to obtain a map and determine a plurality of first nodes in the map, the first nodes being reachable nodes in the map. The node-merging unit is configured to merge the first nodes to obtain one or more second nodes according to a predetermined order based on at least information associated with one or more predetermined rules and mark the first nodes within the second nodes as associated with the second nodes. The path-finding-calculation unit is configured to execute a path-finding algorithm using the second nodes as independent nodes in order to obtain a path from a start node to a target node.

According to yet another embodiment, a non-transitory computer readable storage medium comprises programming instructions for path finding. The programming instructions are configured to cause one or more data processors to execute certain operations. For example, a map is obtained; a plurality of first nodes in the map are determined, the first nodes being reachable nodes in the map; the first nodes are merged to obtain one or more second nodes according to a predetermined order based on at least information associated with one or more predetermined rules; the first nodes within the second nodes are marked as associated with the second nodes; and a path-finding algorithm is executed using the second nodes as independent nodes in order to obtain a path from a start node to a target node.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing application of an A-star path-finding algorithm.

FIG. 2 is a simplified diagram showing a method for path finding according to one embodiment of the present invention.

FIG. 3A is a simplified diagram showing coordinate resetting and FIG. 3B is a simplified diagram showing node merging according to some embodiments of the present invention.

FIG. 4 is a simplified diagram showing a conversion between node coordinates and screen coordinates according to one embodiment of the present invention.

FIG. 5 is a simplified diagram showing a method for path finding using A-start path-finding algorithm according to one embodiment of the present invention.

FIG. 6 is a simplified diagram showing a device for path finding according to one embodiment of the present invention.

FIG. 7 is a simplified diagram showing a device for path finding according to another embodiment of the present invention.

FIG. 8 is a simplified diagram showing a terminal for path finding according to one embodiment of the present invention.

FIG. 9 is a simplified diagram showing comparison of a conventional path-finding device and path-finding devices according to some embodiments of the present invention.

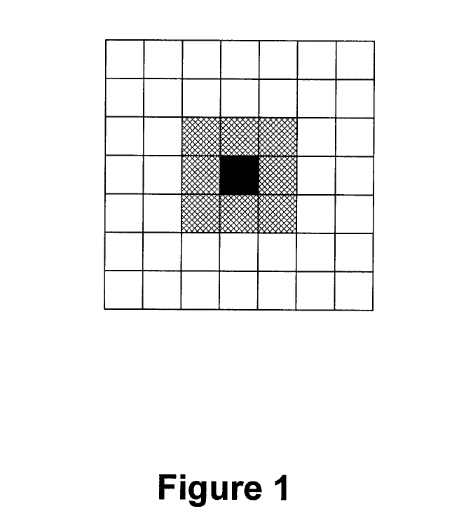

### DETAILED DESCRIPTION OF THE INVENTION

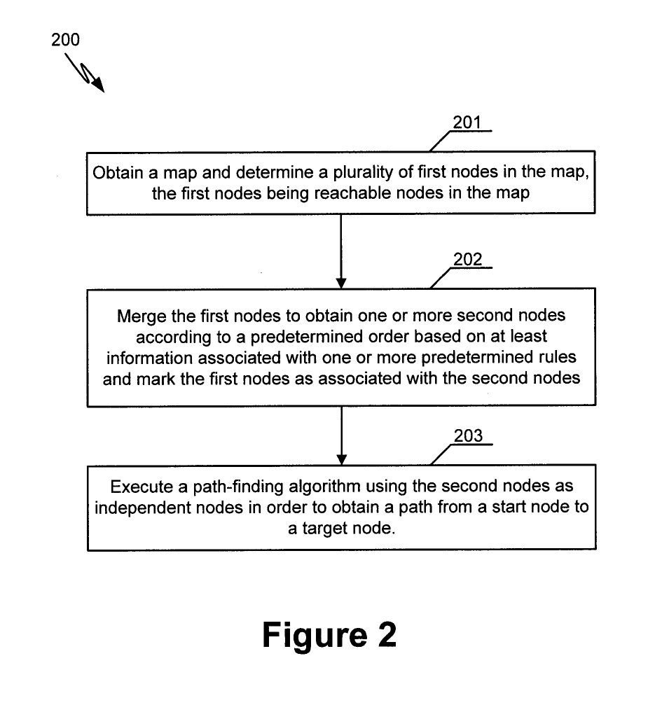

FIG. 2 is a simplified diagram showing a method for path finding according to one embodiment of the present invention. This diagram is merely an example, which should not unduly limit the scope of the claims. One of ordinary skill in the art would recognize many variations, alternatives, and modifications. The method 200 includes at least the processes 201-203.

According to one embodiment, during the process 201, a map is obtained and a plurality of first nodes are determined in the map. For example, the first nodes correspond to reachable nodes in the map. As an example, the map includes a game map in a game, or a real map. In an example, for a game map, the method 200 is applied for path finding in a game executed in a game device. In another example, for a real map, the method 200 is used in path selection and calculation when a robot or other physical entities are moving in the real map.

According to another embodiment, the process 202 includes merging the first nodes to obtain one or more second nodes according to a predetermined order based on at least information associated with one or more predetermined rules, and marking the first nodes within the second nodes as associated with the second nodes. For example, before merging the first nodes in the predetermined order according to the predetermined combination rule, the process 202 further includes: resetting the coordinates of the first nodes to certain coordinates in a same quadrant in a coordinate system. Resetting the coordinates can reduce computational complexity for executing the method 200, in some embodiments.

According to yet another embodiment, the merging the first nodes to obtain one or more second nodes according to a predetermined order based on at least information associated with one or more predetermined rules includes: merging the first nodes based on at least information associated with the one or more predetermined rules row by row starting from a third node at a particular corner of the map, the first nodes including the third node, the third node corresponding to one or more starting coordinates of the quadrant of the coordinate system. For example, the merging the first nodes to obtain one or more second nodes according to a predetermined order based on at least information associated with one or more predetermined rules includes: merging the first nodes based on at least information associated with the one or more predetermined rules column by column starting from the third node at the particular corner of the map, the first nodes including the third node. In another example, the particular corner corresponds to an upper left corner. In yet another example, the particular corner corresponds to a top right corner, a bottom left corner, or a bottom right corner.

In one embodiment, the predetermined rules includes: one or more of the first nodes that are not merged are extended to obtain the second nodes. For example, the second nodes satisfy certain conditions: a length and a width of one of the second nodes are equal; the second nodes do not include a barrier node; and the second nodes do not overlap with each other. In another example, the length and the width of one of the second nodes are not equal. In yet another example, the difference between the length and the width of the second node is within a predetermined range.

In another embodiment, the process 203 includes: executing a path-finding algorithm using the second nodes as independent nodes in order to obtain a path from a start node to a target node. For example, through node merging, the number of nodes for calculation using a path-finding algorithm is reduced so as to improve the path-finding efficiency and reduce the path-finding time to achieve a smoother execution of path-finding in a device. In another example, the path-finding algorithm includes the A-star path-finding algorithm.

In yet another embodiment, executing a path-finding algorithm using the second nodes as independent nodes in order to obtain a path from a start node to a target node includes: when the A-star path-finding algorithm is executed, the first nodes are not extended if the first nodes are marked as associated with the second nodes and the second nodes have been extended, and the first nodes are extended if the first nodes are marked as associated with the second nodes and the second nodes have not been extended.

In some embodiments, the method 200 is implemented for path finding in a game, for example, associated with movements of a game character. As an example, first, a gaming device obtains a game map and identifies multiple first nodes on the game map, where the first nodes corresponds to reachable nodes on the game map. In another example, in contrast, unreachable nodes are terrains or nodes already occupied by another game character. In yet another example, then, the gaming device merges the first nodes in a predetermined order according to a set of predetermined combination rules, to obtain one or more second nodes, and marks the first nodes within the second nodes as associated with the second nodes. In yet another example, finally, the gaming device obtains a current node occupied by the game character (i.e. a start node), and accepts a target destination selected by a user (i.e. a target node). The game device then uses the one or more second nodes as independent nodes, and executes a path-finding algorithm to get the path from the start node to the target node, in some embodiments. For example, as the number of nodes for calculations using the path-finding algorithm is reduced, the path-finding efficiency is improved, and the path-finding time is reduced so that the path-finding performance of the device is improved. Therefore, during the game, even continuous clicks on the map to find a farthest path does not cause freezing, in certain embodiments.

Exemplary descriptions related to coordinates resetting of nodes, node merging, and the execution of the A-star algorithm for a large number of nodes are provided hereinafter.

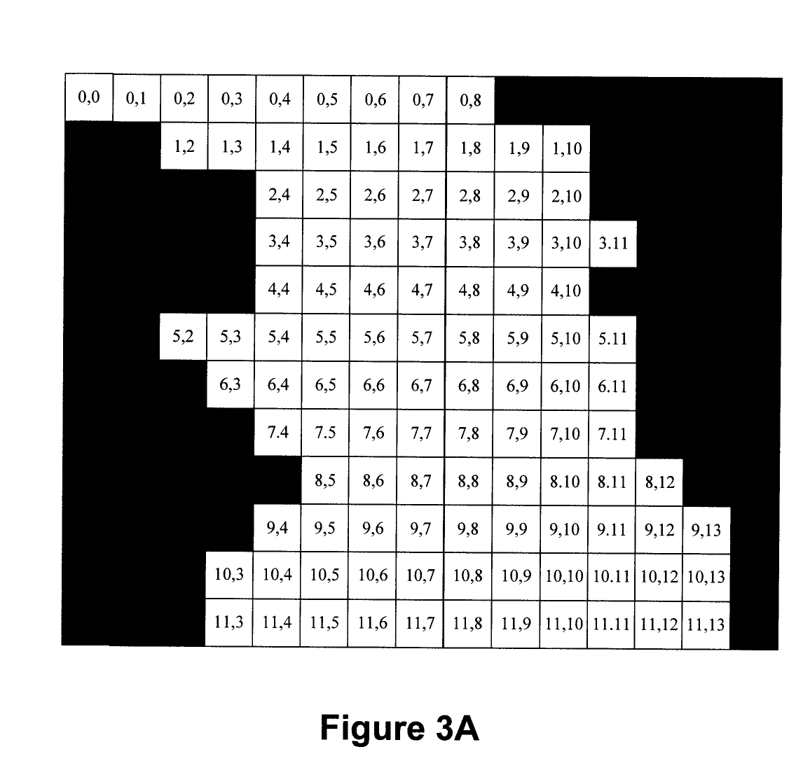

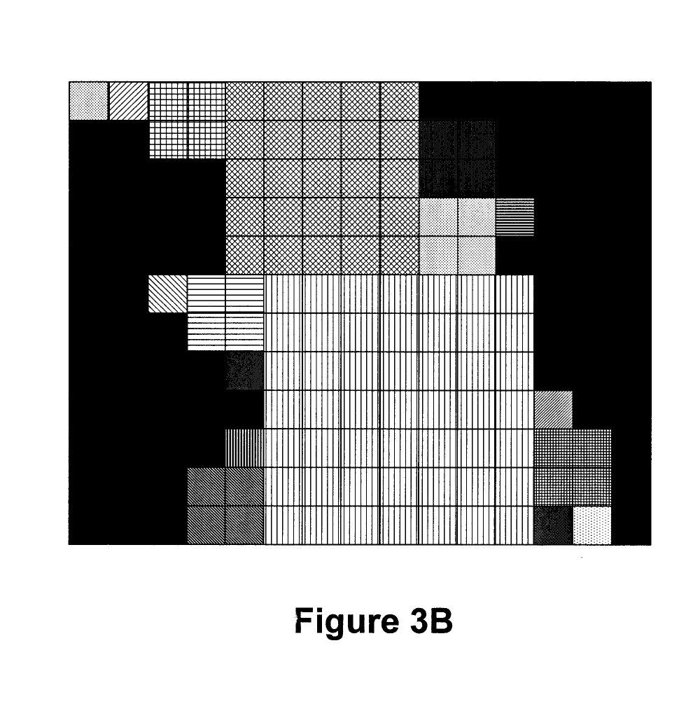

FIG. 3A is a simplified diagram showing coordinate resetting and FIG. 3B is a simplified diagram showing node merging according to some embodiments of the present invention. The diagrams are merely examples, which should not unduly limit the scope of the claims. One of ordinary skill in the art would recognize many variations, alternatives, and modifications.

According to one embodiment, nodes corresponding to the screen displays as shown in FIG. 3A and FIG. 3B are diamond-shaped nodes. For example, as the diamond-shaped nodes with a same x coordinate overlap with each other, it is not easy to obtain the coordinates of eight adjacent nodes. Thus, coordinates of nodes are reset as shown in FIG. 3A, according to an embodiment. For example, nodes in each row have a same x coordinate, and nodes in each column has a same y coordinate. In another example, preferably all of the coordinates are placed in a same quadrant of a coordinate system. As an example, FIG. 3A shows a first quadrant of the coordinate system, and the upper left corner corresponds to the start node (0, 0). It is much easier to access adjacent nodes, considering that the coordinates of the adjacent nodes are often needed for path-finding. The parts filled as black in FIG. 3A correspond to barrier nodes in the terrain, and these barrier nodes do not need to be assigned with certain values, in some embodiments. For example, after the node coordinates are reset, the conversion between the node coordinates and the screen coordinates is carried out frequently. A simple conversion method can improve the efficiency of the algorithm.

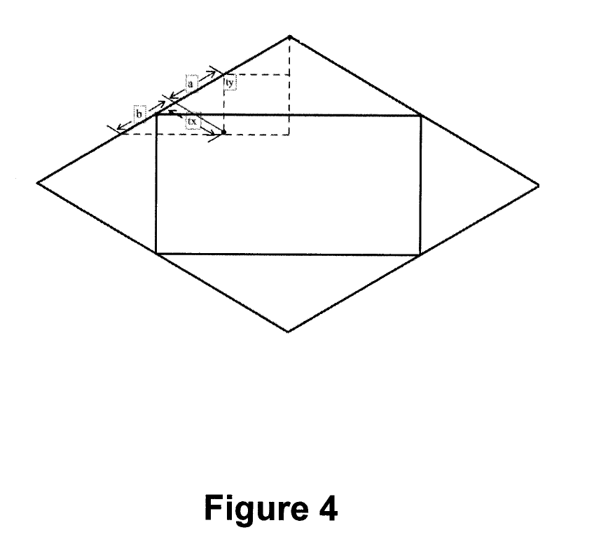

FIG. 4 is a simplified diagram showing a conversion between node coordinates and screen coordinates according to one embodiment of the present invention. The diagram is merely an example, which should not unduly limit the scope of the claims. One of ordinary skill in the art would recognize many variations, alternatives, and modifications.

According to one embodiment, as shown in FIG. 4, the rectangle corresponds to a screen display, and the diamond corresponds to the map. For example, the cross-over point of the rectangle with a line on which “a” and “b” are located corresponds to the origin of the screen coordinates. In another example, the upper corner of the diamond corresponds to the origin of the node coordinates. As an example, the ratio of two diagonals of the diamond corresponds to the ratio of two diagonals of a small node which is predetermined upon editing a scene. As another example, the relative position of the diamond and the screen is predetermined, where the origin of the node coordinates is on a perpendicular bisecting line of the screen. Thus, half of the coordinate values associated with the node-coordinate origin in the screen coordinates are obtained, in some embodiments. For example, a=b=tx. As an example, ty+tx corresponds to the length of hypotenuse of the large triangle, and ty−tx corresponds to the length of hypotenuse of the small triangle above the large triangle, where both the small triangle and the large triangle are right-angled triangles and the ratio of the two right-angle's sides are equal to the ratio of the two diagonals of the diamond. As another example, based on the Pythagorean theorem and the proportional relationships, the lengths of the two dashed lines in FIG. 4 (e.g., the rightmost vertical dashed line of the large dashed triangle and the shorter of the two other dashed lines perpendicular to the rightmost vertical dashed line of the large dashed triangle) are obtained. For example, the lengths of these two dashed lines correspond to a difference in coordinate values between an end point of the line (e.g., tx) in the square and the origin of the node coordinates in the screen coordinate system. As an example, the coordinate values of the end point of the line (e.g., tx) in the screen coordinate system are obtained. The conversion from the screen coordinates to node coordinates includes a process similar to what is described above, in certain embodiments.

According to another embodiment, the quality of node merging also affects the path-finding efficiency. For example, the larger the merged nodes (e.g., the second nodes) are, the fewer the merged nodes, which benefits path finding. As an example, a simple greedy algorithm is implemented for node merging. Specifically, small nodes (e.g., the first nodes) are traversed row by row and/or column by column, in some embodiments. For example, a small node can be traversed and has not been associated with a large node. In another example, the small node is used as the upper left corner of the rectangle. In yet another example, a large square is selected to include reachable small nodes that are not traversed to be merged into a large node. In yet another example, the square shape is selected for the large node is because if the width and the length of a large node are allowed to be unequal, due to the characteristics of the greedy algorithm, a long bar-shaped large node can appear (e.g., with a length and a width of 1×n). When the greedy algorithm is used to progressively merge nodes from the upper left corner row by row, the long bar-shaped large node is good for path finding if the path is toward the bottom right direction. On the other hand, the long bar-shaped node may reduce the path-finding efficiency if the path is toward the upper right direction when too many adjacent nodes are added. Thus, the long bar-shaped large node may cause unbalanced path-finding efficiency, in some circumstances. In contrast, the method as shown in FIG. 3B is used to merge nodes, the path-finding efficient is comparable along all directions, in some embodiments.

According to yet another embodiment, as shown in FIG. 3B and FIG. 3A, the traversal starts from a small node with coordinates (0, 0) progressively, row by row. For example, the parts filled as black in FIG. 3A and FIG. 3B correspond to barrier nodes. As an example, the principles of node merging include: 1. large nodes (e.g., the second nodes) do not overlap with each other; 2. large nodes (e.g., the second nodes) do not contain barrier nodes; 3. a width and a length of a large node are equal; and/or other suitable principles. As another example, if point a (e.g., a small node (0, 4)) is used as a top left corner of a large node, a 5×5 large node is obtained. For example, then, another small node that is not a barrier node and is not associated with any large node is searched for row by row and/or column by column, and such a small node is used as a top left corner of another large node to begin merging again.

According to yet another embodiment, as shown in FIG. 3A, the traversal starts from a small node with coordinates (0, 0) progressively, row by row. For example, the (0, 0) node and the (0, 1) node are determined to not satisfy the merging principles, and the (0, 0) node and the (0, 1) node are not merged. In another example, the (0, 2) node can be used to merge four small nodes, including (0, 2), (0, 3), (1, 2) and (1, 3), into a large node. In yet another example, the (0, 4) node can be used to merge multiple small nodes into a large node similarly. FIG. 3B illustrates the results of the node merging, where the small nodes with a same line-shade belong to a same large node (i.e., a second node).

In one embodiment, a small node at an upper left corner of a large node is used as a marker of the large node (e.g., point a). For example, each small node is configured to have an is Sign field to indicate whether it is a marker of a large node. If the small node is a marker, then it includes two fields—width and height to record the width and the height of the associated large node. Otherwise, the small node includes two fields—signX and signY to record the coordinates of a marker of the associated large node. In another example, each small node is determined whether it is associated with a large node, and the length and the width of the associated large node based on the above-noted field data. As shown in FIG. 3B, the traversal starts at a particular small node (e.g., point a) and a next reachable node is searched for, in some embodiments. For example, the next reachable node is not limited to the eight adjacent small nodes, because all small nodes within a large node are reachable (e.g., through a straight line). Thus, peripheral small nodes in the large node are traversed, including the small nodes (0, 3), (1, 3), (5, 3), (5, 4), (5, 5), (5, 6), (5, 7), (5, 8), (5, 9), (4, 9), (3, 9), (2, 9) and (1, 9) as shown in FIG. 3A, in certain embodiments. That is, multiple small nodes are traversed in a single step. Similarly, when a large node is reached, it is considered that all small nodes within the large node are reached to avoid repeating the search for these small nodes.

In another embodiment, the A-star algorithm is used for path finding. For example, the A-star algorithm includes two important functions: g(n) and h(n), where g(n) represents a cost from a start node to a current node and h (n) represents a cost estimate from the current node to a target node. h(n) is also known as a heuristic function. In another example, g(n) is defined as a sum of the cost associated with a length of the path from the start node to the current node and the cost associated with turns on the path. The number of turns on the path is considered because in an actual game, the absolute shortest length of the path is not necessarily required, but the reasonableness of the path is also important. For example, even though some paths have longer absolute lengths, but game users may prefer other paths because the other paths avoid frequent turning. In another example, h(n) is defined as a linear distance between the current node and the target node. In yet another example, h(n) is monotonic, so that a minimum cost associated with reaching a node is found before the node is placed into a Close table in order to reduce the cost related to modifying nodes in the Close table. h(n) satisfies the condition h(n)≦h*(n), where h*(n) represents a theoretical minimum from the current node to the destination node, so that the A-star algorithm can find an optimal solution, in some embodiments.

In yet another embodiment, large nodes are used to optimize path-finding using the A-star algorithm. The large nodes play a significant role in path finding, for example, in extending a particular node. As an example, the extension of a particular node includes searching for all reachable nodes starting from the particular node. In another example, all small nodes within a large node are mutually reachable in a straight-line manner. All nodes surrounding the large node can be traversed when extending a small node in the large node. If these surrounding nodes are reachable and are not in the Close table, then these nodes are added to the Open table, in some embodiments.

According to one embodiment, when a small node is retrieved from the Open table, whether a large node associated with the small node is in the Close table is determined. For example, if the large node is in the Close table, then the small node is not extended, and another small node is retrieved from the Open table for extension. In another example, if the large node is not in the Close table, the large node is then put into the Close table, and the small node is extended. As an example, putting the large node into the Close table includes: putting a marker of the large node into the Close table. In some embodiments, many small nodes within a same large node are skipped in the-path finding process to improve the search efficiency.

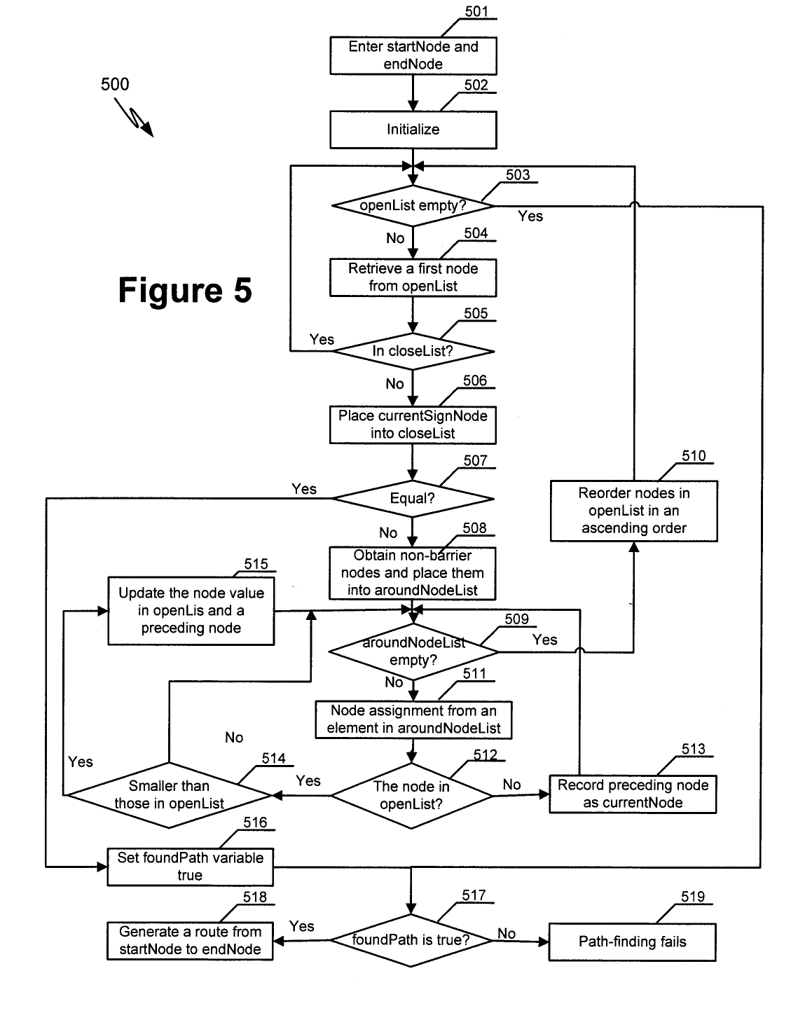

FIG. 5 is a simplified diagram showing a method for path finding using A-start path-finding algorithm according to one embodiment of the present invention. The diagram is merely an example, which should not unduly limit the scope of the claims. One of ordinary skill in the art would recognize many variations, alternatives, and modifications.

According to one embodiment, during the process 501, at the start of the A-star path-finding algorithm, a start node (i.e., startNode) and a target node (i.e., endNode) are entered. For example, the nodes startNode and endNode are both small nodes and are not barrier nodes. In another example, during the process 502, the A-star path-finding algorithm is initialized. In yet another example, the initialization of the A-star path-finding algorithm includes the following operations: 1. obtaining a maker node of a large node to which the node endNode belongs, the marker node being represented as endSignNode; 2. using a variable foundPath to indicate whether a feasible path has been found and setting an initial value of the variable foundPath to false; 3. using a table openList to save one or more current reachable nodes which have not been extended (the extended nodes are put in a table closeList), the node startNode being put into the table openList during the initialization process.

According to another embodiment, during the process 503, whether the table openList is empty is determined. For example, if the table openList is empty, the process 517 is executed. Otherwise, the process 504 is executed. In another example, after the process 503, a search logic loop is entered and the loop has two termination conditions: a feasible path has been found, and the table openList becomes empty. As an example, the table openList becomes empty indicates that no feasible path exists between the start node and the target node.

According to yet another embodiment, during the process 504, a first node is retrieved from the table openList, and denoted as currentNode. For example, the table openList orders the small nodes in an ascending order according to evaluation values associated with the nodes. In another example, if the large node that a retrieved node belongs to has already been extended, then the retrieved node is discarded and a next node is retrieved instead, because the extension results of each small node within a same large node are the same.

According to yet another embodiment, during the process 505, the currentNode is contained in a large node which has a marker of currentSignNode. For example, whether the currentSignNode is already in the table closeList is determined. If the currentSignNode is already in the table closeList, the currentNode is discarded, and the process 503 is executed. Otherwise, the process 506 is executed, in some embodiments.

In one embodiment, during the process 506, when the large node that includes the currentNode is not extended, the currentSignNode corresponding to the currentNode is put into the table closeList so as to mark that the large node as being extended. For example, during the process 507, the currentSignNode and the endSignNode obtained during the initialization process are compared to determine whether the two are equal. In an example, if the currentSignNode and the endSignNode are equal, a large node associated with the target node is reached. The path-finding process is successful, and the process 516 is executed. In another example, if the large node associated with the target node is not reached, further extension is needed, and the process 508 is executed.

In another embodiment, during the process 508, all the surrounding non-barrier nodes of the large node associated with the current node are obtained, and put into a table aroundNodeList. For example, then the process 509 is executed. In another example, during the process 509, whether the table aroundNodeList is empty is determined. In yet another example, if the table aroundNodeList is empty, the process 510 is executed. In yet another example, if the table aroundNodeList is not empty, the process 511 is executed.

In yet another embodiment, during the process 510, the nodes in the table openList are reordered based on related evaluation values in an ascending order, and then the process 503 is executed. For example, during the process 511, a node is assigned from the table aroundNodeList. In another example, the process 512 is executed, and whether the assigned node is in openList is determined. In yet another example, if the assigned node is not in openList, the process 513 is executed. In yet another example, if the assigned node is in openList, the process 514 is executed.

In yet another embodiment, during the process 513, a value is calculated for the assigned node, and another node that precedes the assigned node is recorded as currentNode. For example, the assigned node is added to openList, and then the process 509 is executed. In another example, during the process 514, if the assigned node is already in openList, then a value is calculated for the assigned node and whether the calculated value associated with the assigned node is smaller than an evaluation value associated with the assigned node in the table openList is determined. As an example, the calculated value of the assigned node is smaller than the evaluation value in the table openList, the process 515 is executed. Otherwise, the process 509 is executed. As another example, during the process 515, the evaluation value associated with the assigned node and a node that precedes the assigned node are updated. In another example, the preceding node is recorded as currentNode, and then the process 509 is executed.

In yet another embodiment, new nodes are added to openList, which affects the original order of the nodes in the table openList. For example, after all nodes in aroundNodeList are processed, the nodes in openList are reordered based on evaluation values in an ascending order. As an example, an actual path through which a node is reached and a distance between the node and the target node are used as the evaluation value of the node. Until now, an extension of nodes is completed and the search loop restarts.

According to one embodiment, during the process 516, the variable foundPath variable is set to true. For example, during the process 517, whether the variable foundPath is true is determined. If foundPath is true, the process 518 is executed. Otherwise, the process 519 is executed, in some embodiments. For example, during the process 518, if the variable foundPath is true, the path has been found. As an example, the path is generated from startNode to endNode, and the path-finding process ends.

According to another embodiment, when the search loop ends, a path-finding failure is returned if the path is not found. For example, when the search loop ends, if a large node containing the target node is reached, a traversal is performed from currentNode through recorded preceding nodes until the startNode is reached. In another example, the path from the startNode to the large node containing the target node is obtained. The endNode representing the target node is added to generate the full path from the startNode to the endNode, in certain embodiments. For example, during the process 519, the path-finding process fails and ends.

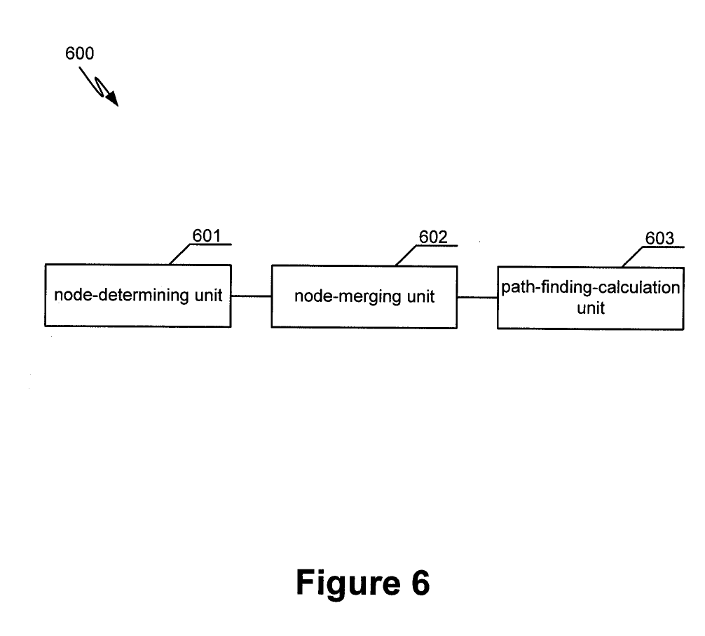

FIG. 6 is a simplified diagram showing a device for path finding according to one embodiment of the present invention. The diagram is merely an example, which should not unduly limit the scope of the claims. One of ordinary skill in the art would recognize many variations, alternatives, and modifications. The device 600 includes a node-determining unit 601, a node-merging unit 602, and a path-finding-calculation unit 603.

According to one embodiment, the node-determining unit 601 is configured to obtain a map and determine a plurality of first nodes in the map, the first nodes being reachable nodes in the map. For example, the node-merging unit 602 is configured to merge the first nodes determined by the node-determination unit 601 to obtain one or more second nodes according to a predetermined order based on at least information associated with one or more predetermined rules and mark the first nodes within the second nodes as associated with the second nodes. In another example, the path-finding-calculation unit 603 is configured to execute a path-finding algorithm using the second nodes obtained by the node-merging unit 602 as independent nodes in order to obtain a path from a start node to a target node. Through node merging, the device 600 reduces the number of nodes used is the calculation using a path-finding algorithm to improve the path-finding efficiency and reduce the path-finding time so that the path-finding process is more smoothly executed by the device 600.

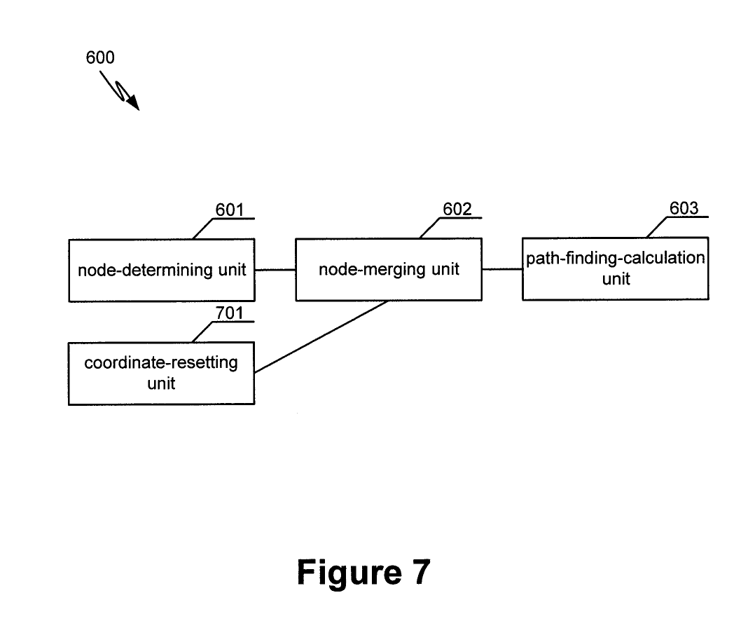

FIG. 7 is a simplified diagram showing the device 600 according to another embodiment of the present invention. The diagram is merely an example, which should not unduly limit the scope of the claims. One of ordinary skill in the art would recognize many variations, alternatives, and modifications.

According to one embodiment, the device 600 further includes a coordinate-resetting unit 604 configured to reset first coordinates of the first nodes to second coordinates in a same quadrant of a coordinate system, e.g., before the node-merging unit 602 merges the first nodes based on at least information associated with one or more predetermined rules. For example, the node-merging unit 602 is further configured to merge the first nodes based on at least information associated with the one or more predetermined rules row by row starting from a third node at a particular corner of the map, the first nodes including the third node, the third node corresponding to one or more starting coordinates of the coordinate system. In another example, the node-merging unit 602 is further configured to merge the first nodes based on at least information associated with the one or more predetermined rules column by column starting from a third node at a particular corner of the map, the first nodes including the third node, the third node corresponding to one or more starting coordinates of the coordinate system.

According to another embodiment, the node-merging unit 602 is further configured to extend one or more of the first nodes that are not merged to obtain the second nodes. For example, the second nodes satisfy certain conditions: a length and a width associated with one of the second nodes are equal; the second nodes do not include a barrier node; and the second nodes do not overlap.

According to yet another embodiment, as shown in FIG. 3B and FIG. 3A, the traversal starts from a small node with coordinates (0, 0) progressively, row by row. For example, the parts filled as black in FIG. 3A and FIG. 3B correspond to barrier nodes. As an example, the principles of node merging include: 1. large nodes (e.g., the second nodes) do not overlap with each other; 2. large nodes (e.g., the second nodes) do not contain barrier nodes; 3. a width and a length of a large node are equal; and/or other suitable principles. As another example, if point a (e.g., a small node (0, 4)) is used as a top left corner of a large node, a 5×5 large node is obtained. For example, then, another small node that is not a barrier node and is not associated with any large node is searched for row by row and/or column by column, and such a small node is used as a top left corner of another large node to begin merging again.

According to yet another embodiment, as shown in FIG. 3A, the traversal starts from a small node with coordinates (0, 0) progressively, row by row. For example, the (0, 0) node and the (0, 1) node are determined to not satisfy the merging principles, and the (0, 0) node and the (0, 1) node are not merged. In another example, the (0, 2) node can be used to merge four small nodes, including (0, 2), (0, 3), (1, 2) and (1, 3), into a large node. In yet another example, the (0, 4) node can be used to merge multiple small nodes into a large node similarly. FIG. 3B illustrates the results of the node merging, where the small nodes with a same line-shade belong to a same large node (i.e., a second node).

In one embodiment, the path-finding-calculation unit 603 is further configured to execute an A-star path-finding algorithm using the second nodes obtained by the node-merging unit 602 as the independent nodes in order to obtain the path from the start node to the target node. For example, during the execution of the A-star path-finding algorithm, the path-finding-calculation unit 603 is further configured to receive a third node included in the first nodes, and in response to the third node being marked as associated with a fourth node included in the second nodes, not extend the third node in response to the fourth node having been extended and extend the third node in response to the fourth node having not been extended. In some embodiments, the path-finding device 600 includes one or more devices that execute a path-finding program. For example, the path-finding device 600 includes a terminal, a server, a robot, etc.

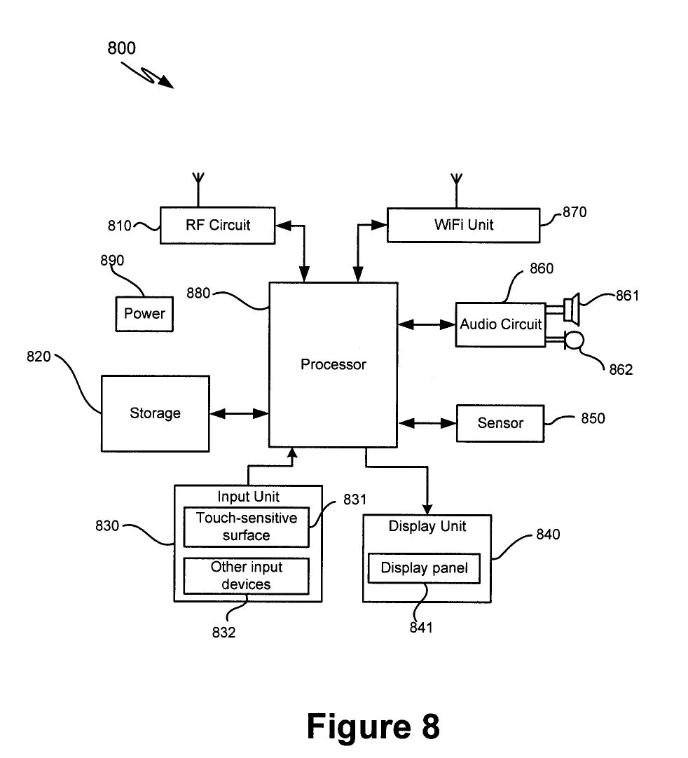

FIG. 8 is a simplified diagram showing a terminal for path finding according to one embodiment of the present invention. The diagram is merely an example, which should not unduly limit the scope of the claims. One of ordinary skill in the art would recognize many variations, alternatives, and modifications. For example, the terminal 800 includes a mobile phone, a tablet PC, a PDA (Personal Digital Assistant), a POS (Point of Sales terminal), a car computer or any terminal equipment.

According to one embodiment, the terminal 800 (e.g., a mobile phone) includes a RF (i.e., radio frequency) circuit 810, a memory 820 that includes one or more computer-readable storage medium, an input unit 830, a display unit 840, a sensor 850, an audio circuit 860, a WiFi (i.e., wireless fidelity) module 870, one or more processors 880 that includes one or more processing cores, and a power supply 890. For example, the RF circuit 810 is configured to send/receive messages or signals in communication. As an example, the RF circuit 810 receives a base station's downlink information, delivers to the processors 880 for processing, and sends uplink data to the base station. For example, the RF circuit 810 includes an antenna, at least one amplifier, a tuner, one or several oscillators, SIM (Subscriber Identity Module) card, a transceiver, a coupler, an LNA (Low Noise Amplifier) and a duplexer. In another example, the RF circuit 810 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

According to another embodiment, the memory 820 is configured to store software programs and modules. For example, the processors 880 are configured to execute various functional applications and data processing by running the software programs and modules stored in the memory 820. The memory 820 includes a program storage area and a data storage area, where the program storage area may store the operating system, and the application(s) required by one or more functions (e.g., an audio player or a video player), in some embodiments. For example, the data storage area stores the data created based on the use of the terminal 800 (e.g., audio data or a phone book). In another example, the memory 820 includes a high-speed random access storage, a non-volatile memory, one or more floppy disc storage devices, a flash storage device or other volatile solid storage devices. As an example, the memory 820 further includes a memory controller to enable access to the memory 820 by the processors 880 and the input unit 830.

According to yet another embodiment, the input unit 830 is configured to receive an input number or character data and generate inputs for a keyboard, a mouse, and a joystick, optical or track signals relating to user setting and functional control. For example, the input unit 830 includes a touch-sensitive surface 831 and other input devices 832. The touch-sensitive surface 831 (e.g., a touch screen or a touch panel) is configured to receive the user's touch operations thereon or nearby (e.g., the user's operations on or near the touch-sensitive surface with a finger, a touch pen or any other appropriate object or attachment) and drive the corresponding connected devices according to the predetermined program. For example, the touch-sensitive surface 831 includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processors 880 and receives and executes the commands received from the processors 880. For example, the touch-sensitive surface 831 is of a resistance type, a capacitance type, an infrared type and a surface acoustic wave type. In another example, other than the touch-sensitive surface, the input unit 830 includes the other input devices 832. For example, the other input devices 832 include one or more physical keyboards, one or more functional keys (e.g., volume control keys or switch keys), a track ball, a mouse and/or a joystick.

According to yet another embodiment, the display unit 840 is configured to display data input from a user or provided to the user, and includes various graphical user interfaces of the terminal 800. For example, these graphical user interfaces include menus, graphs, texts, icons, videos and a combination thereof. The display unit 840 includes a display panel 841 which contains a LCD (liquid crystal display), an OLED (organic light-emitting diode). As an example, the touch-sensitive surface can cover the display panel 841. For example, upon detecting any touch operations thereon or nearby, the touch-sensitive surface sends signals to the processors 880 to determine the type of the touch events and then the processors 880 provides corresponding visual outputs on the display panel 841 according to the type of the touch events. Although the touch-sensitive surface 831 and the display panel 841 are two independent parts for input and output respectively, the touch-sensitive surface 831 and the display panel 841 can be integrated for input and output, in some embodiments.

In one embodiment, the terminal 800 includes a sensor 850 (e.g., an optical sensor, a motion sensor or other sensors). For example, the sensor 850 includes an environment optical sensor and adjusts the brightness of the display panel 841 according to the environmental luminance. In another example, the sensor 850 includes a proximity sensor and turns off or backlights the display panel when the terminal 800 moves close to an ear of a user. In yet another example, the sensor 850 includes a motion sensor (e.g., a gravity acceleration sensor) and detects a magnitude of acceleration in all directions (e.g., three axes). Particularly, the sensor 850 detects a magnitude and a direction of gravity when staying still. In some embodiments, the sensor 850 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 850 includes a gyroscope, a barometer, a hygroscope, a thermometer and/or an infrared sensor.

In another embodiment, the audio circuit 860, a speaker, and a microphone are configured to provide an audio interface between a user and the terminal 800. For example, the audio circuit 860 is configured to transmit electrical signals converted from certain audio data to the speaker that converts such electrical signals into some output audio signals. In another example, the microphone is configured to convert audio signals into electrical signals which are converted into audio data by the audio circuit 860. The audio data are processed in the processors 880 and received by the RF circuit 810 before being sent to another terminal, in some embodiments. For example, the audio data are output to the memory 820 for further processing. As an example, the audio circuit 860 includes an earphone jack for communication between a peripheral earphone and the terminal 800.

WiFi is a short-distance wireless transmission technology. In some embodiments, through the WiFi module 870, the terminal 800 enables the user to receive and send emails, browse webpages, and/or access stream media. For example, the terminal 800 is configured to provide the user with a wireless broadband Internet access. In some embodiments, the WiFi module 870 is omitted in the terminal 800.

According to one embodiment, the processors 880 are the control center of the terminal 800. For example, the processors 880 is connected to various parts of the terminal 800 (e.g., a cell phone) via various interfaces and circuits, and executes various features of the terminal 800 and processes various data through operating or executing the software programs and/or modules stored in the memory 820 and calling the data stored in the memory 820, so as to monitor and control the terminal 800 (e.g., a cell phone). As an example, the processors 880 include one or more processing cores. In another example, the processors 880 is integrated with an application processor and a modem processor, where the application processor mainly handles the operating system, the user interface and the applications and the modem processor mainly handles wireless communications. In some embodiments, the modem processor is not integrated into the processors 880.

According to another embodiment, the terminal 800 includes the power supply 890 (e.g., a battery) that powers up various parts. For example, the power supply 890 is logically connected to the processors 880 via a power source management system so that the charging, discharging and power consumption can be managed via the power source management system. In another example, the power supply 890 includes one or more DC or AC power sources, a recharging system, a power-failure-detection circuit, a power converter, an inverter, a power source state indicator, or other components. In yet another example, the terminal 800 includes a camcorder, a Bluetooth module, etc. Specifically, the processors 880 of the terminal 800 load executable files associated with one or more applications to the memory 820 and run the applications stored in the memory 820 according to the method 100, the method 200, and/or the method 300.

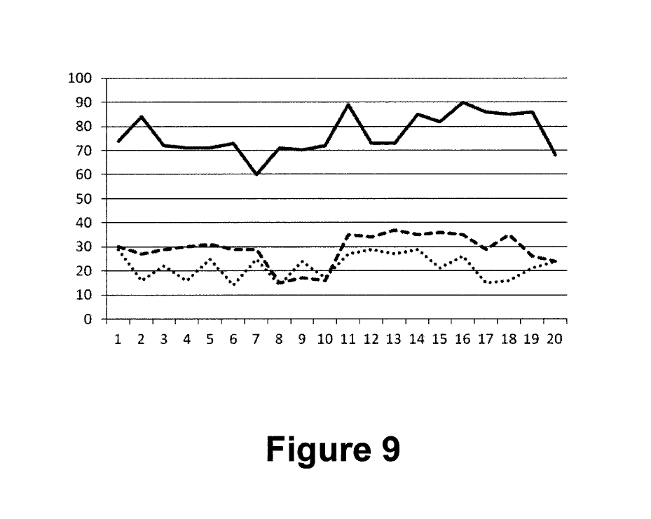

FIG. 9 is a simplified diagram showing comparison of a conventional path-finding device and path-finding devices according to some embodiments of the present invention. The diagram is merely an example, which should not unduly limit the scope of the claims. One of ordinary skill in the art would recognize many variations, alternatives, and modifications.

In some embodiments, a test is performed using a game software. For example, a test method includes clicking on a farthest point on a small map so that a character runs a diagonal line and then runs back to the origin point. As an example, ten successive clicks of the mouse yield twenty sets of data. In another example, a Scout tool is used to obtain the time related to the execution of ActionScript codes in a frame.

The results are shown in FIG. 9, where a horizontal axis represents the number of tests and a vertical axis represents time values in milliseconds, in certain embodiments. A solid line represents the execution time using a conventional path-finding device, a segmented line represents the execution time using a path-finding device according to one embodiment of the present invention, and a dotted line represents the execution time using a path-finding device according to another embodiment of the present invention (e.g., without considering costs associated with turning). For example, the optimized path-finding algorithm according to certain embodiments of the present invention greatly improves efficiency and reduces the time required to find the path (e.g., to around 50%). The path-finding time is saved if the node costs are calculated without considering the turning cost, in some embodiments. The path found is less tortuous and more natural if the turning cost is considered, in certain embodiments. Continuous clicks on the map to find the farthest path does not cause freezing, in some embodiments.

According to one embodiment, a method is provided for path finding. For example, a map is obtained; a plurality of first nodes in the map are determined, the first nodes being reachable nodes in the map; the first nodes are merged to obtain one or more second nodes according to a predetermined order based on at least information associated with one or more predetermined rules; the first nodes within the second nodes are marked as associated with the second nodes; and a path-finding algorithm is executed using the second nodes as independent nodes in order to obtain a path from a start node to a target node. For example, the method is implemented according to at least FIG. 2, and/or FIG. 5.

According to another embodiment, a device for path finding includes: a node-determining unit, a node-merging unit, and a path-finding-calculation unit. The node-determining unit is configured to obtain a map and determine a plurality of first nodes in the map, the first nodes being reachable nodes in the map. The node-merging unit is configured to merge the first nodes to obtain one or more second nodes according to a predetermined order based on at least information associated with one or more predetermined rules and mark the first nodes within the second nodes as associated with the second nodes. The path-finding-calculation unit is configured to execute a path-finding algorithm using the second nodes as independent nodes in order to obtain a path from a start node to a target node. For example, the device is implemented according to at least FIG. 6, and/or FIG. 7.

According to yet another embodiment, a non-transitory computer readable storage medium comprises programming instructions for path finding. The programming instructions are configured to cause one or more data processors to execute certain operations. For example, a map is obtained; a plurality of first nodes in the map are determined, the first nodes being reachable nodes in the map; the first nodes are merged to obtain one or more second nodes according to a predetermined order based on at least information associated with one or more predetermined rules; the first nodes within the second nodes are marked as associated with the second nodes; and a path-finding algorithm is executed using the second nodes as independent nodes in order to obtain a path from a start node to a target node. For example, the storage medium is implemented according to at least FIG. 2, and/or FIG. 5.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for path finding, comprising:
obtaining a map;
determining a plurality of first nodes in the map, the first nodes being reachable nodes in the map;
merging the first nodes to obtain one or more second nodes according to a predetermined order based on at least information associated with one or more predetermined rules;
marking the first nodes within the second nodes as associated with the second nodes; and
executing a path-finding algorithm using the second nodes as independent nodes in order to obtain a path from a start node to a target node.

2. The method of claim 1, further comprising:
resetting first coordinates of the first nodes to second coordinates in a same quadrant of a coordinate system.

3. The method of claim 2, wherein the merging the first nodes to obtain one or more second nodes according to a predetermined order based on at least information associated with one or more predetermined rules includes:
merging the first nodes based on at least information associated with the one or more predetermined rules row by row starting from a third node at a particular corner of the map, the first nodes including the third node, the third node corresponding to one or more starting coordinates of the quadrant of the coordinate system.

4. The method of claim 2, wherein the merging the first nodes to obtain one or more second nodes according to a predetermined order based on at least information associated with one or more predetermined rules includes:
merging the first nodes based on at least information associated with the one or more predetermined rules column by column starting from a third node at a particular corner of the map, the first nodes including the third node, the third node corresponding to one or more starting coordinates of the quadrant of the coordinate system.

5. The method of claim 1, wherein:
the predetermined rules includes: one or more of the first nodes that are not merged are extended to obtain the second nodes;
a length and a width associated with one of the second nodes are equal;
the second nodes do not include a barrier node; and
the second nodes do not overlap with each other.

6. The method of claim 1, wherein the path-finding algorithm includes an A-star path-finding algorithm.

7. The method of claim 6, wherein:
the executing a path-finding algorithm using the second nodes as independent nodes in order to obtain a path from a start node to a target node includes: executing the A-star path-finding algorithm; and
the executing the A-star path-finding algorithm includes:
receiving a third node included in the first nodes;
in response to the third node being marked as associated with a fourth node included in the second nodes,
not extending the third node in response to the fourth node having been extended; and
extending the third node in response to the fourth node having not been extended.

8. A device for path finding, comprising:
a node-determining unit configured to obtain a map and determine a plurality of first nodes in the map, the first nodes being reachable nodes in the map;
a node-merging unit configured to merge the first nodes to obtain one or more second nodes according to a predetermined order based on at least information associated with one or more predetermined rules and mark the first nodes within the second nodes as associated with the second nodes;
a path-finding-calculation unit configured to execute a path-finding algorithm using the second nodes as independent nodes in order to obtain a path from a start node to a target node.

9. The device of claim 8, further comprising:
a coordinate-resetting unit configured to reset first coordinates of the first nodes to second coordinates in a same quadrant of a coordinate system.

10. The device of claim 8, wherein:
the node-merging unit is further configured to merge the first nodes based on at least information associated with the one or more predetermined rules row by row starting from a third node at a particular corner of the map, the first nodes including the third node, the third node corresponding to one or more starting coordinates of the coordinate system.

11. The device of claim 8, wherein:
the node-merging unit is further configured to merge the first nodes based on at least information associated with the one or more predetermined rules column by column starting from a third node at a particular corner of the map, the first nodes including the third node, the third node corresponding to one or more starting coordinates of the coordinate system.

12. The device of claim 8, wherein:
the node-merging unit is further configured to extend one or more of the first nodes that are not merged to obtain the second nodes,
a length and a width associated with one of the second nodes are equal;
the second nodes do not include a barrier node; and
the second nodes do not overlap.

13. The device of claim 8, wherein:
the path-finding-calculation unit is further configured to execute an A-star path-finding algorithm using the second nodes as the independent nodes in order to obtain the path from the start node to the target node.

14. The device of claim 13, wherein during the execution of the A-star path-finding algorithm, the path-finding-calculation unit is further configured to,
receive a third node included in the first nodes; and
in response to the third node being marked as associated with a fourth node included in the second nodes,
not extend the third node in response to the fourth node having been extended; and
extend the third node in response to the fourth node having not been extended.

15. The device of claim 8, further comprising:
one or more data processors; and
a computer-readable storage medium;
wherein one or more of the node-determining unit, the node-merging unit, and the path-finding-calculation unit are stored in the storage medium and configured to be executed by the one or more data processors.

16. A non-transitory computer readable storage medium comprising programming instructions for path finding, the programming instructions configured to cause one or more data processors to execute operations comprising:
obtaining a map;
determining a plurality of first nodes in the map, the first nodes being reachable nodes in the map;
merging the first nodes to obtain one or more second nodes according to a predetermined order based on at least information associated with one or more predetermined rules;
marking the first nodes within the second nodes as associated with the second nodes; and
executing a path-finding algorithm using the second nodes as independent nodes in order to obtain a path from a start node to a target node.
